(19) United States
(12) Patent Application Publication
(10) Pub. No.: US 2024/0066756 A1
(43) Pub. Date: Feb. 29, 2024

(54) CUTTING MACHINE

(71) Applicant: HONDA MOTOR CO., LTD., Tokyo (JP)

(72) Inventor: Kota TOKUBI, Wako-shi (JP)

(21) Appl. No.: 17/894,109

(22) Filed: Aug. 23, 2022

(51) Int. Cl. B28D 7/02; B28D 1/04

(52) U.S. Cl. CPC B28D 7/02; B28D 1/047

(57) ABSTRACT

The present invention provides a cutting machine that cuts a structure by pressing a disk-shaped blade against the structure while rotating the blade, comprising: a machine body having wheels and rotatably supporting the blades; a tank that stores water to be supplied to the blade for cooling the blade; and a motor for rotationally driving the blade, wherein the tank and the motor are arranged such that the tank and the motor at least partially overlap each other in a top view of the cutting machine.

### BACKGROUND OF THE INVENTION

### Field of the Invention

The present invention relates to a cutting machine.

### Description of the Related Art

Japanese Patent Laid-Open No. 11-140817 discloses a concrete cutter that rotates a rotary blade by power of an engine. Further, in the concrete cutter described in Japanese Patent Laid-Open No. 11-140817, an electric motor for obtaining a propulsive force is provided.

In recent years, in order to reduce CO₂ emissions in view of climate-related disasters, electrification of work machines has been advanced, and work machines are shifting to configurations in which work is performed by power of a motor. Also in a cutting machine (cutter) that cuts a structure such as the ground, there are plans to use a motor and a battery to rotationally drive a rotary blade (blade). In such a cutting machine, as the capacity of the tank that stores the cooling water of the blade increases, the frequency of replenishing the tank with the cooling water decreases, which can be advantageous in terms of workability of the cutting work of the structure. Therefore, in electrification of the cutting machine, it is desirable to arrange the motor and the tank such that the capacity of the tank is as large as possible.

### SUMMARY OF THE INVENTION

The present invention provides, for example, a cutting machine that is advantageous in terms of the capacity of the tank that stores the cooling water of the blade.

According to one aspect of the present invention, there is provided a cutting machine that cuts a structure by pressing a disk-shaped blade against the structure while rotating the blade, comprising: a machine body having wheels and rotatably supporting the blades; a tank that stores water to be supplied to the blade for cooling the blade; and a motor for rotationally driving the blade, wherein the tank and the motor are arranged such that the tank and the motor at least partially overlap each other in a top view of the cutting machine.

Further features of the present invention will become apparent from the following description of exemplary embodiments with reference to the attached drawings.

### BRIEF DESCRIPTION OF THE DRAWINGS

FIG. 1 is a view illustrating a configuration example of a cutting machine according to an embodiment of the present invention;

FIG. 2 is a block diagram (top view) schematically illustrating the cutting machine according to the embodiment of the present invention;

FIG. 3 is a block diagram (top view) schematically illustrating the cutting machine according to the embodiment of the present invention;

FIG. 4 is a block diagram (side view) schematically illustrating the cutting machine according to the embodiment of the present invention; and

FIG. 5 is a block diagram (side view) schematically illustrating the cutting machine according to the embodiment of the present invention.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

A cutting machine 10 according to an embodiment of the present invention will be described. In each drawing described below, arrows X, Y, and Z indicate directions orthogonal to each other, with an X direction indicating the front-and-rear direction of the cutting machine 10, a Y direction indicating the width direction (left-and-right direction) of the cutting machine 10, and a Z direction indicating the up-and-down direction of the cutting machine 10. In the present embodiment, the +X direction indicates the traveling direction of the cutting machine 10, and with respect to the traveling direction, the +Y direction indicates the left direction (the left side of the cutting machine 10), and the −Y direction indicates the right direction (the right side of the cutting machine 10).

### Configuration Example of Cutting Machine

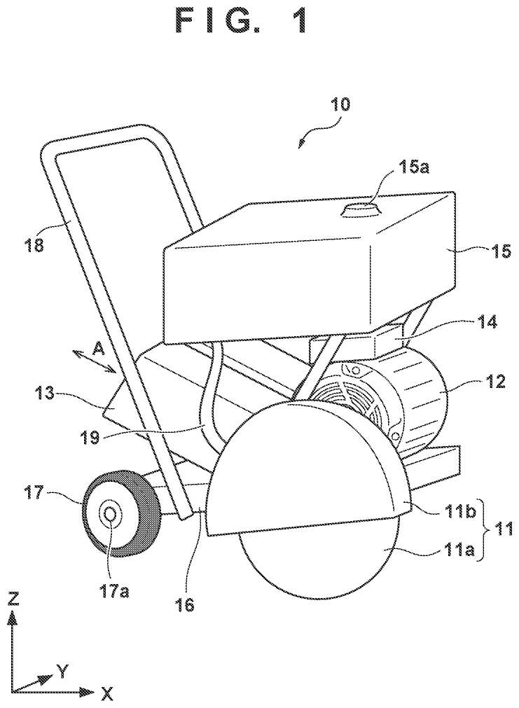

FIG. 1 illustrates a configuration example of the cutting machine 10 according to the present embodiment. The cutting machine 10 is a work machine that cuts a structure by pressing a disk-shaped blade 11a against the structure while rotating the blade, and may be referred to as a cutter. The cutting machine 10 of the present embodiment is an electric work machine including a working unit 11, a motor 12, a battery 13, a power control unit 14, a tank 15, a machine body 16 (base), a pair of left and right wheels 17, and a handle 18. Examples of the structure to be cut by the cutting machine 10 according to the present embodiment include a road surface, a floor surface, and a floor plate made of concrete, asphalt, or the like. Note that the cutting machine 10 of the present embodiment is configured as a hand push type in which the operator travels by gripping and manually pushing the handle 18, but it may be configured as a tractor type that the operator can board.

The working unit 11 is a unit for performing cutting work of a structure by rotating the blade 11a by the power of the motor 12. In the case of the present embodiment, the working unit 11 may include the disk-shaped blade 11a rotatably supported by the machine body 16 and a cover member 11b attached to the machine body 16 to cover an upper portion of the blade 11a. Note that the working unit 11 is not limited to a configuration that performs cutting work by rotating the blade 11a, and may have another type of configuration. In the example of FIG. 1, the working unit 11 is provided on the side portion of the machine body 16, but is not limited thereto, and may be provided at any position of the machine body 16 (for example, a center portion of the machine body 16 in the width direction).

The motor 12 is a driving source that includes a stator and a rotor, and generates power (rotational force) for rotating the rotor by energizing a coil provided on one of the stator and the rotor. In the present embodiment, the motor 12 is arranged such that the rotary shaft (rotor) extends in the width direction (Y direction). That is, the motor 12 is arranged such that the direction parallel to the rotary shaft of the motor 12 is the width direction. The rotary shaft (rotor) of the motor 12 and the rotary shaft of the blade 11a are connected by a power transmission mechanism such as a belt, and the power of the motor 12 is transmitted to the blade 11a via the power transmission mechanism, and thus the blade 11a can be rotationally driven. Note that the blade 11a can be attachable to and detachable from the machine body 16 (replaceable).

The battery 13 is an electric power source that stores electric power to be supplied to the motor 12. The battery 13 of the present embodiment can be an attachable and detachable battery configured to be attachable to and detachable from the machine body 16. For example, the cutting machine 10 may be configured to include a holder for attachably and detachably holding the battery 13 on the machine body 16. In the example of FIG. 1, a plurality of (two) batteries 13 are mounted to the rear portion of the machine body 16 in the width direction, but only one battery 13 may be mounted, or three or more batteries 13 may be mounted.

The battery 13 of the present embodiment is arranged behind the motor 12 in the front-and-rear direction (X direction), and is configured (arranged) such that the operator can attach and detach (insert and remove) the battery 13 to and from the rear part (rear portion) of the machine body 16 (cutting machine 10) as indicated by an arrow A in FIG. 1. In addition, the battery 13 is arranged to be inclined backward such that an upper end of the battery 13 is positioned behind a lower end of the battery 13. As a result, attachment and detachment (insertion and removal) of the battery 13 with respect to the machine body 16 can be performed on the rear side of the machine body 16 (handle 18), which is a standing position of the operator during the cutting work, and thus, workability of replacement of the battery 13 can be improved.

The power control unit 14 is, for example, a power control unit (PCU), and controls power to be supplied from the battery 13 to the motor 12. In FIG. 1, the power control unit 14 is arranged above the motor 12. By arranging the power control unit 14 in this manner, the power control unit 14 can be arranged away from the contact part between the structure in which dust is generated and the blade 11a, and the influence of dust on the power control unit 14 can be reduced. Note that the power control unit 14 may be integrated with the motor 12.

The tank 15 is a water storage container that stores water to be supplied to the blade 11a in order to cool the blade 11a that generates frictional heat in cutting work, and is arranged above the working unit 11 (blade 11a) in the up-and-down direction (Z direction). A tube 19 (water supply path) is connected to the bottom portion of the tank 15 and the cover member 11b of the working unit 11, and a certain amount of water is sequentially supplied from the inside of the tank 15 to the blade 11a via the tube 19 by gravity. A supply port 15a for supplying water into the tank 15 is provided in the upper portion of the tank 15.

Here, the water stored in the tank 15 may be used not only for cooling the blade 11b but also for cooling (water-cooling) the motor 12. For example, a water jacket (flow path) for circulating water around the motor 12 may be provided around the motor 12, and the water in the tank 15 may be supplied to the water jacket via a tube to cool (water-cooling) the motor 12. In this case, the motor 12 can be efficiently cooled (water-cooled), and a tank for storing water for cooling the motor 12 does not need to be separately provided, which can also be advantageous for making the cutting machine 10 compact.

The machine body 16 is configured as a base that supports the working unit 11, the motor 12, the battery 13, the tank 15, and the like. That is, the working unit 11, the motor 12, the battery 13 (or the holder of the battery 13), the tank 15 and the like are attached to the machine body 16. Further, a pair of left and right wheels 17 are pivotally supported to be rotatable on a rear portion of the machine body 16. Specifically, an axle 17a extending in the left-and-right direction (Y direction) is pivotally supported to be rotatable by the machine body 16, and a pair of left and right wheels 17 are attached to an end portion of the axle 17a. Note that the cutting machine 10 of the present embodiment has a configuration including a pair of left and right two wheels 17, but may have a configuration including three or more wheels. For example, in addition to the pair of left and right wheels 17 provided at the rear portion of the machine body 16, a three-wheel or four-wheel configuration including one or more wheels provided at the front portion of the machine body 16 may be employed.

The handle 18 is a member gripped by an operator to manually push the cutting machine 10. A work machine having the handle 18 is called a hand push type work machine or a walking type work machine, and an operator can perform cutting work by gripping the handle 18 in an upright state and pushing the cutting machine 10. The handle 18 may be provided with an operation unit for an operator to operate the cutting machine 10.

[Arrangement Requirements of Components in Cutting Machine]

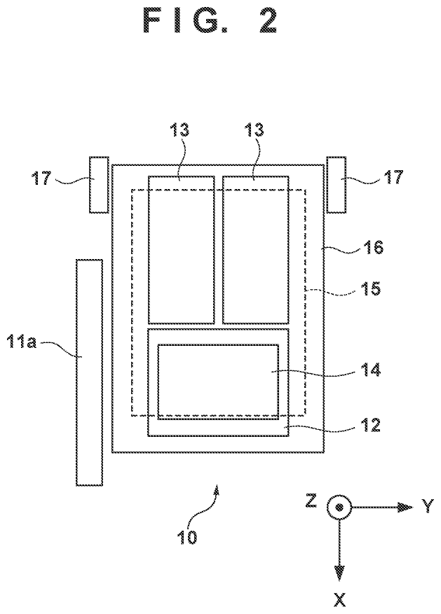

In the cutting machine 10, as the capacity of the tank 15 storing the cooling water of the blade 11b increases, the frequency of replenishing the tank 15 with the cooling water decreases, which can be advantageous in terms of workability of the cutting work. Therefore, in electrification of the cutting machine 10, it is desirable to arrange the motor 12 or the tank 15 such that the capacity of the tank 15 is as large as possible. Hereinafter, the arrangement requirements of components capable of increasing the capacity of the tank 15 will be described with reference to FIGS. 2 to 5. FIGS. 2 to 5 are block diagrams schematically illustrating the blade 11a, the motor 12, the battery 13, the power control unit 14, the tank 15, the machine body 16, the wheel 17, and the handle 18 in the cutting machine 10, and are used to describe the following arrangement requirements 1 to 7. In the cutting machine 10 of the present embodiment, not all of the arrangement requirements 1 to 7 described below are essential. The arrangement requirement 1 may be understood as being essential to the cutting machine 10 of the present embodiment, but the arrangement requirement 2 to 7 can be applied to the cutting machine 10 of the present embodiment in any manner. In addition, the cutting machine 10 of the present embodiment may include configuration requirements specified (defined) in FIGS. 1 to 5 in addition to or instead of the following arrangement requirements 1 to 7.

(Arrangement Requirement 1)

The arrangement requirement 1 is that, as illustrated in FIG. 2, the tank 15 and the motor 12 are arranged such that the tank 15 and the motor 12 at least partially overlap each other in a top view of the cutting machine 10 (that is, when the cutting machine 10 is viewed from above). FIG. 2 is a schematic view of the cutting machine 10 from above. According to such an arrangement, the tank 15 can be expanded in the front-and-rear direction and/or in the width direction on the machine body 16 regardless of the position of the motor 12, and thus the capacity of the tank 15 can be increased. In addition, regardless of the position of the motor 12, the tank 15 can be arranged in a design considering the weight balance of the cutting machine 10, and thus the traveling stability of the cutting machine 10 and the workability of the cutting work can be improved.

(Arrangement Requirement 2)

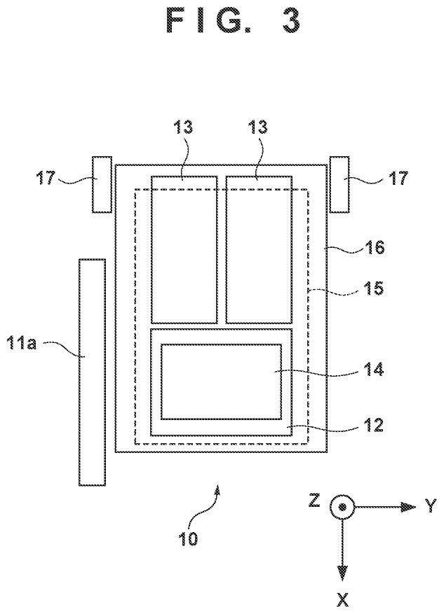

In the arrangement requirement 2, as illustrated in FIG. 3, the tank 15 and the motor 12 are arranged such that the entire motor 12 overlaps the tank 15 in a top view of the cutting machine 10 and an upper portion of the motor 12 is covered with a part of the tank 15. FIG. 3 is a schematic view of the cutting machine 10 from above. According to such an arrangement, since a part of the tank 15 is arranged above the motor 12, the motor 12 can be protected from rain or the like by the tank 15. In addition, the power control unit 14 may also be arranged to be covered with a part of the tank 15. For example, the power control unit 14 can be arranged between the motor 12 and the tank 15.

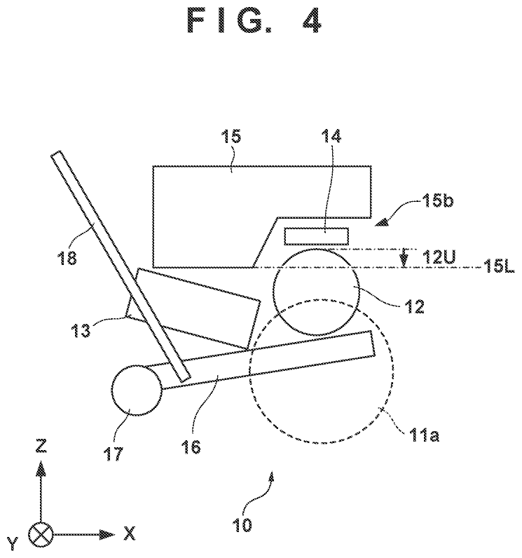

Here, in the above-described arrangement requirements 1 and 2, as illustrated in FIG. 4, the tank 15 and the motor 12 may be arranged such that a lower end 15L of the tank 15 is positioned below an upper end 12U of the motor 12 in the up-and-down direction (Z direction). FIG. 4 is a schematic view of the cutting machine 10 from the side. For example, the tank 15 and the motor 12 may be arranged such that the upper portion of the motor 12 is accommodated in a recess portion 15b (depression) provided at a part of the lower surface of the tank 15. In this case, since a part of the tank 15 can also be arranged in the gap generated on the side of the motor 12, the capacity of the tank 15 can be increased.

(Arrangement Requirement 3)

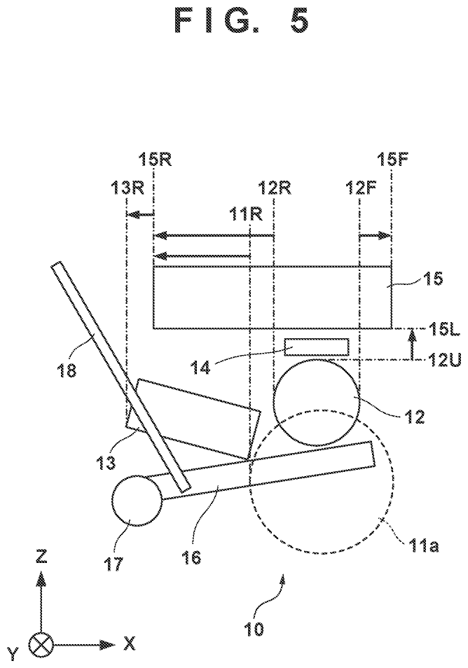

The arrangement requirement 3 is that, as illustrated in FIG. 5, the tank 15 and the motor 12 are arranged such that the lower end 15L of the tank 15 is positioned above an upper end 12U of the motor 12 in the up-and-down direction (Z direction). FIG. 5 is a schematic view of the cutting machine 10 from the side. According to such an arrangement, a space above the motor 12 in the up-and-down direction can be freely used as an arrangement place of the tank 15. Therefore, the tank 15 can be configured in a simple shape, and the degree of freedom in arrangement of the tank 15 can be expanded.

(Arrangement Requirement 4)

The arrangement requirement 4 is that, as illustrated in FIG. 5, the tank 15 and the motor 12 are arranged such that a rear end 15R of the tank 15 is positioned behind a rear end 12R of the motor 12 in the front-and-rear direction (X direction). According to such an arrangement, since the tank 15 can be expanded toward the rear side of the cutting machine 10, the capacity of the tank 15 can be increased.

(Arrangement Requirement 5)

The arrangement requirement 5 is that, as illustrated in FIG. 5, the tank 15 and the motor 12 are arranged such that a front end 15F of the tank 15 is positioned in front of a front end 12F of the motor 12 in the front-and-rear direction (X direction). According to such an arrangement, since the tank 15 can be expanded toward the front side of the cutting machine 10, the capacity of the tank 15 can be increased.

(Arrangement Requirement 6)

The arrangement requirement 6 is that, as illustrated in FIG. 5, the tank 15 and the working unit 11 (blade 11a) are arranged such that the rear end 15R of the tank 15 is positioned behind a rear end 11R of the blade 11a in the front-and-rear direction (X direction). According to such an arrangement, since the tank 15 can be expanded toward the rear side of the cutting machine 10, the capacity of the tank 15 can be increased.

(Arrangement Requirement 7)

The arrangement requirement 7 is that, as illustrated in FIGS. 2 and 3, the tank 15 and the battery 13 are arranged such that the tank 15 and the battery 13 at least partially overlap each other in a top view (that is, when the cutting machine 10 is viewed from above) of the cutting machine 10. According to such an arrangement, the tank 15 can be expanded in the front-and-rear direction and/or in the width direction on the machine body 16 regardless of the position of the battery 13, and thus the capacity of the tank 15 can be increased.

In addition, in the arrangement requirement 7, as illustrated in FIG. 5, the tank 15 and the battery 13 may be arranged such that the rear end 13R of the battery 13 is positioned behind the rear end 15R of the tank 15 in the front-and-rear direction (X direction). According to such an arrangement, it is possible to avoid the tank 15 from becoming an obstacle when the operator attaches and detaches (inserts and removes) the battery 13 from the rear part of the machine body 16, and thus, it is possible to improve workability of replacement of the battery 13.

### Summary of Embodiments

1. A cutting machine of the above embodiments is a cutting machine (e.g. 10) that cuts a structure by pressing a disk-shaped blade (e.g. 11a) against the structure while rotating the blade, comprising:
a machine body (e.g. 16) having wheels (e.g. 17) and rotatably supporting the blades;
a tank (e.g. 15) that stores water to be supplied to the blade for cooling the blade; and
a motor (e.g. 12) for rotationally driving the blade,
wherein the tank and the motor are arranged such that the tank and the motor at least partially overlap each other in a top view of the cutting machine.

According to this configuration, the tank can be expanded in the front-and-rear direction and/or in the width direction on the machine body regardless of the position of the motor, and thus the capacity of the tank can be increased. In addition, regardless of the position of the motor, the tank can be arranged in a design considering the weight balance of the cutting machine, and thus the traveling stability of the cutting machine and the workability of the cutting work can be improved.

2. In the above embodiments,
the tank and the motor are arranged such that the entire motor overlaps the tank in a top view of the cutting machine and an upper portion of the motor is covered with a part of the tank.

According to this configuration, since a part of the tank is arranged above the motor, the motor can be protected from rain or the like by the tank.

3. In the above embodiments,
the tank and the motor are arranged such that a lower end (e.g. 15L) of the tank is positioned below an upper end (e.g. 12U) of the motor in an up-and-down direction of the cutting machine.

According to this configuration, since a part of the tank can also be arranged in the gap generated on the side of the motor, the capacity of the tank can be increased.

4. In the above embodiments,
the tank and the motor are arranged such that a lower end (e.g. 15L) of the tank is positioned above an upper end (e.g. 12U) of the motor in an up-and-down direction of the cutting machine.

According to this configuration, since the space above the motor in the up-and-down direction can be freely used as the arrangement place of the tank, the tank can be configured in a simple shape, and the degree of freedom in arrangement of the tank can be widened.

5. In the above embodiments,
the tank and the motor are arranged such that a rear end (e.g. 15R) of the tank is positioned behind a rear end (e.g. 12R) of the motor in a front-and-rear direction of the cutting machine.

According to this configuration, since the tank can be expanded toward the rear side of the cutting machine, the capacity of the tank can be increased.

6. In the above embodiments,
the tank and the motor are arranged such that a front end (e.g. 15F) of the tank is positioned in front of a front end (e.g. 12F) of the motor in a front-and-rear direction of the cutting machine.

According to this configuration, since the tank can be expanded toward the front of the cutting machine, the capacity of the tank can be increased.

7. In the above embodiments,
the tank is arranged such that a rear end (e.g. 15R) of the tank is positioned behind a rear end (e.g. 11R) of the blade in the front-and-rear direction of the cutting machine.

According to this configuration, since the tank can be expanded toward the rear side of the cutting machine, the capacity of the tank can be increased.

8. In the above embodiments,
the cutting machine further comprises: a battery (e.g. 13) that stores electric power to be supplied to the motor,
wherein the battery is configured such that an operator can attach and detach the battery to and from the machine body from a rear part of the machine body.

According to this configuration, since a portable battery can be used, usability of the cutting machine can be improved. In addition, attachment and detachment (insertion and removal) of the battery with respect to the machine body can be performed on the rear side of the machine body, which is a standing position of the operator during the cutting work, and thus, workability of replacement of the battery can be improved.

9. In the above embodiments,
the tank and the battery are arranged such that the tank and the battery at least partially overlap each other in a top view of the cutting machine.

According to this configuration, the tank can be expanded in the front-and-rear direction and/or in the width direction on the machine body regardless of the position of the battery, and thus the capacity of the tank can be increased.

10. In the above embodiments,
the tank and the battery are arranged such that a rear end (e.g. 13R) of the battery is positioned behind a rear end (e.g. 15R) of the tank in a front-and-rear direction of the cutting machine.

According to this configuration, it is possible to avoid the tank from becoming an obstacle when the operator attaches and detaches the battery from the rear part of the machine body, and thus, it is possible to improve workability of battery replacement.

11. In the above embodiments,
the battery is arranged to be inclined backward such that an upper end of the battery is positioned behind a lower end of the battery.

According to this configuration, workability of battery replacement by an operator can be improved.

12. In the above embodiments,
the cutting machine is a hand push type work machine having a handle (e.g. 18) gripped by an operator.

According to this configuration, a hand push type cutting machine is provided.

The invention is not limited to the foregoing embodiments, and various variations/changes are possible within the spirit of the invention.

What is claimed is:

1. A cutting machine that cuts a structure by pressing a disk-shaped blade against the structure while rotating the blade, comprising:
a machine body having wheels and rotatably supporting the blades;
a tank that stores water to be supplied to the blade for cooling the blade; and
a motor for rotationally driving the blade,
wherein the tank and the motor are arranged such that the tank and the motor at least partially overlap each other in a top view of the cutting machine.

2. The cutting machine according to claim 1, wherein the tank and the motor are arranged such that the entire motor overlaps the tank in a top view of the cutting machine and an upper portion of the motor is covered with a part of the tank.

3. The cutting machine according to claim 1, wherein the tank and the motor are arranged such that a lower end of the tank is positioned below an upper end of the motor in an up-and-down direction of the cutting machine.

4. The cutting machine according to claim 1, wherein the tank and the motor are arranged such that a lower end of the tank is positioned above an upper end of the motor in an up-and-down direction of the cutting machine.

5. The cutting machine according to claim 1, wherein the tank and the motor are arranged such that a rear end of the tank is positioned behind a rear end of the motor in a front-and-rear direction of the cutting machine.

6. The cutting machine according to claim 1, wherein the tank and the motor are arranged such that a front end of the tank is positioned in front of a front end of the motor in a front-and-rear direction of the cutting machine.

7. The cutting machine according to claim 1, wherein the tank is arranged such that a rear end of the tank is positioned behind a rear end of the blade in the front-and-rear direction of the cutting machine.

8. The cutting machine according to claim 1, further comprising: a battery that stores electric power to be supplied to the motor,
wherein the battery is configured such that an operator can attach and detach the battery to and from the machine body from a rear part of the machine body.

9. The cutting machine according to claim 8, wherein the tank and the battery are arranged such that the tank and the battery at least partially overlap each other in a top view of the cutting machine.

10. The cutting machine according to claim 8, wherein the tank and the battery are arranged such that a rear end of the battery is positioned behind a rear end of the tank in a front-and-rear direction of the cutting machine.

11. The cutting machine according to claim 8, wherein the battery is arranged to be inclined backward such that an upper end of the battery is positioned behind a lower end of the battery.

12. The cutting machine according to claim 1, wherein the cutting machine is a hand push type work machine having a handle gripped by an operator.
